(19) United States
(12) Patent Application Publication
(10) Pub. No.: US 2010/0083625 A1
(43) Pub. Date: Apr. 8, 2010

(54) Mower mate

(76) Inventor: Matthew Sean Blair, Belton, SC (US)

Correspondence Address: Matthew Blair, 4044 Belhaven Rd., Belton, SC, 29627, US

(21) Appl. No.: 12/287,229

(22) Filed: Oct. 7, 2008

(51) Int. Cl. A01D 75/00

(52) U.S. Cl. 56/1

(57) ABSTRACT

Is a combination Tool Kit and Lawn Care Product Containment Devise which is strapped over and on top of a Riding Lawn Mower Motor Housing. The Mower Mate will allow for frequently used tools and lawn care products to be kept with the Riding Lawn Mower and application of Lawn Care Products while mowing.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM CD APPENDIX

None

### 1. BACKGROUND OF THE INVENTION

To my knowledge there are no referenced specific documents relating to My invention and there are no problems involving prior art which my invention is drawn toward.

### 2. CONCEPTION RECORD

While cutting my grass I noticed ant hills and weeds in my yard. I thought of how nice it would be if I could have ant and or weed killer with me while I mowed the grass. The idea came to me to have an attached bag which could hold a bottle of ant and or weed killer which I could spray while I cut the grass. During my contemplation of a devise which would serve this purpose a spindle housing on my lawn mower broke. While making the repair I noticed I spent a lot of time looking for the tools I use when making repairs to my lawn mower. I conceived of having a tool kit on the other side of my lawn mower with the purpose of saving myself the frustration of spending time looking for the tools I use most often making mower repairs.

### 3. STATEMENT OF FIELD INVENTION PERTAINS

Lawn and Garden Maintenance and Equipment Repair

### 4. BRIEF SUMMARY OF THE INVENTION

The Mower Mate is a combination of a Tool Kit for frequently used tools for mower repair in combination with a Bag (compartment) which is intended for the carrying of lawn care (Ant/Weed Killer) products for the purpose of application of products while mowing grass.

### 5. A BRIEF DESCRIPTION OF SEVERAL VIEWS OF THE DRAWING

### Substitute Specification Requirement as Per Required by Formalities Letter *OC000000032912351* Confirmation No. 7733 Date Mailed: 11/04/08

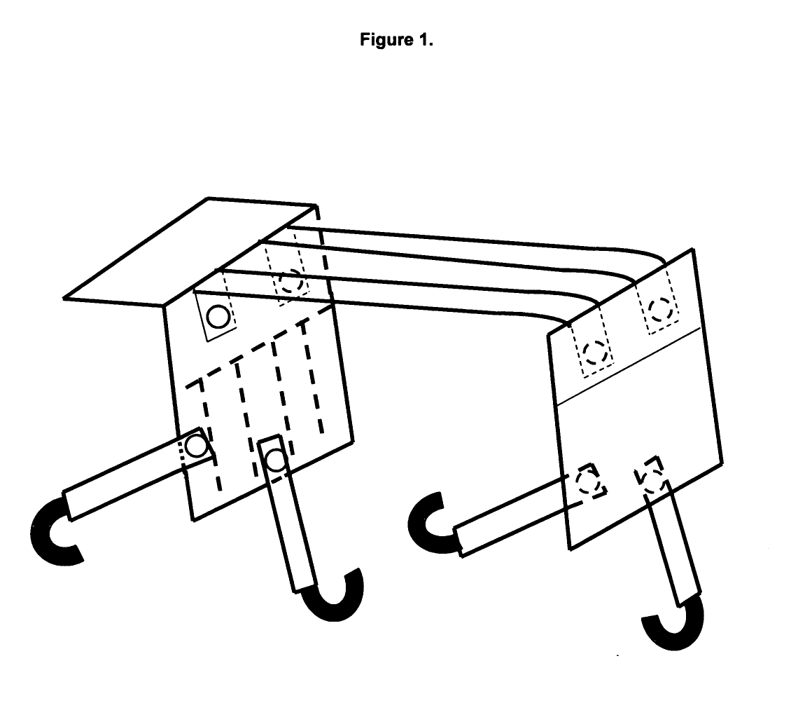

FIG. 1 of the Drawing depicts, on the left of the drawing, a tool kit made of textile material which will accommodate up to 4 wrenches and 3 sockets. The tool kit will have a flap which will cover the tools. The tool kit will be supported by 2 straps fastened to the back of the tool kit and extending over the top of the motor housing and lacing into buckles at the end of the straps supporting the holster for chemicals (which is depicted at the right of the drawing, 1 strap and hook which will hook to the bottom of the motor housing or mower frame depending on the design of the mower. The tool kit will be supported by a strap and hook which will be fasted to the side of the motor housing toward the steering wheel. The holster for chemicals will be supported by 2 straps fastened to the holster and having buckles affixed to the bitter end of the straps allowing for the tool kit top housing straps to be laced through. The holster will be supported by 1 strap with hook to secure to the bottom of the mower housing or frame depending on the design of the mower. The holster will be supported by 1 strap and hook which will hook to the side of the motor housing toward the steering wheel.

### 6. ADVANTAGES OF INNOVATION

The advantages of this innovation are the ease of application of lawn care products while mowing one's lawn and conveniently having the frequently used tools for mower repair maintained with the mower.

### 7. RAMIFICATIONS

I believe this original concept will allow for convenient and ease of application of lawn care products while allowing for quick retrieval of tools frequently used for mower repair.

### 8. ADDITIONAL BENEFITS

Additional benefits of this invention are limited only by the creativity of the user because the compartments can be used for unidentified purposes by the inventor.

### 9. DISTINGUISHED FROM OTHER INVENTIONS

### Closes Known Design:

To my knowledge there is currently no design which meets the practical applications of this original concept.

1: The invention will enhance ease of application of lawn care products such as Ant Killer and Weed Killer while mowing (with respect to marketing considerations).
As the original inventor I, Matthew Sean Blair, claim that the concept for the above described Mower Mate is of original concept and design to address the scope of any and all lawn care applications while mowing.

2: The invention will enhance the retrieval for use of frequently used tools for mower repair.
As the original inventor I, Matthew Sean Blair, claim that the concept for the above described Mower Mate is of original concept and design to address the

3: The scope of this invention is limited only be the creativity of the users for multi-purpose applications and use of the product. Additional adaptations will fall within the scope of this claim.
